(19) United States
(12) Patent Application Publication
(10) Pub. No.: US 2025/0139340 A1
(43) Pub. Date: May 1, 2025

(54) METHOD AND FRAMEWORK FOR DESIGNING OF VLSI CIRCUIT USING GRAPHICAL USER INTERFACE

(71) Applicant: Compcarta Solutions Pvt. Ltd., Greater Noida (IN)

(72) Inventors: Gagan Deep Singh, Bijnor (IN); Jigyasa Singh, Bijnor (IN)

(21) Appl. No.: 18/926,432

(22) Filed: Oct. 25, 2024

(30) Foreign Application Priority Data
Oct. 30, 2023 (IN) 202311073877

(51) Int. Cl. G06F 30/31; G06F 9/445; G06F 30/327

(52) U.S. Cl. CPC G06F 30/31; G06F 9/44526; G06F 30/327

(57) ABSTRACT

The present invention relates to a method and framework for designing of VLSI circuit using graphical user interface. The method comprises of selecting one or more components from a design tool bar module and/or a user library module configured within a graphical user interface (GUI) for creating a system/circuit design; providing connectivity information representing interconnections or interface between the selected components of the system design over a design plane or form by the user; specifying input and output ports information for the system design; specifying a hardware description language (HDL) from plurality of HDLs for HDL code generation into a hardware description language module; a timing waveform creation module configured to generate timing waveforms representing digital signals of the generated design; a low power intent module to low power circuit design, and generating the power intent into a UPF.

### EARLIEST PRIORITY DATE

This application claims priority from a patent application filed in India having patent application No. 202311073877, filed on Oct. 30, 2024, titled “METHOD AND FRAMEWORK FOR DESIGNING OF VLSI CIRCUIT USING GRAPHICAL USER INTERFACE”

### FIELD OF INVENTION

The present invention generally relates to field of integrated circuits. The present invention particularly relates to a method and framework for designing of Very-large-scale integration (VLSI) circuit using an electronic design automation (EDA) software, and more particularly a graphical user interface (GUI) for design and product validation operation.

### BACKGROUND OF THE INVENTION

Millions of transistors are not unusual in today's integrated circuits (ICs). The task of designing these integrated circuits has become proportionally more demanding. What was once done by a single person or a small group of people is now usually done by a huge team or numerous teams of design engineers. The field of circuit design has undergone significant advancements and innovations in response to the increasing demand for complex digital systems. Designers strive to create circuits that are efficient, consume less power, reliable, and tailored to specific requirements. However, the process of circuit design can be challenging and time-consuming, often involving complex tools and specialized software.

The clock route has long been one of the most crucial and complicated design aspects. With rising feature complexities, test architecture and low power designers are now dealing with several clocks as well as the regulating logic, making the clock path considerably more complex and difficult. Thus, the clock route's significance extends beyond static timing analysis to encompass its crucial role in silicon behavior and system design. Furthermore, despite the impressive rate of development and evolution of EDA tools, flaws and challenges linked with clock path design only rise as technology and architecture evolve. Several considerations, such as domain crossover, Design for Testability (DFT), and power, must be addressed when building the clock route. In addition to addressing functional requirements, it is essential to ensure that a design meets its power specifications and behaves correctly in low-power modes. A Low Power Specification, utilizing the Unified Power Format (UPF), consists of a set of rules and directives that provide guidance for designing and verifying low-power ICs within the realm of electronic design automation. UPF is a standardized format used for specifying and managing power-saving strategies in VLSI designs.

There are several patent applications that provide HDL code generation. One such Patent Application is U.S. Pat. No. 10,157,045B2 discloses systems and methods may automatically generate code for deep learning networks. The system and method may provide a code generation framework for generating target specific code. The code generation framework may include one or more predefined class hierarchies for constructing objects of the generated code. The objects of the class hierarchies may provide an interface to predefined libraries of deep learning functions optimized for use on a target platform. The systems and methods may perform one or more optimizations on the code being generated. The aforementioned prior art utilized deep learning systems for code generation and unable to design and draw waveform for waveform analysis using a single platform.

There are patents in the prior art that are computer-based, generating HDL from graphical interfaces for various applications. However, when it comes to focusing specifically on HDL generation, Low power specification generation (e.g. UPF) and waveform creation within a graphical interface, there remains a gap in the prior art.

In view of the above problems associated with the state of the art, there is a need for a system or method to allow users to create a graphical model by simply dragging and dropping blocks from a library browser onto a graphical editor.

### OBJECTIVES OF THE INVENTION

The primary objective of the present invention is to provide a platform which can perform designing of VLSI circuit and automatically generate HDL code.

Another objective of the present invention is to provide a framework for performing timing waveform analysis which enables accurate assessment of signal behaviour.

Another objective of the present invention is to provide a platform that can specify power intent during circuit design and generate low-power specifications in a format like UPF.

Another objective of the present invention is to provide a platform that is configured to generate other information used in the VLSI design, such as Synopsys design constraints (SDC), Design Exchange Format file (def).

Yet another objective of the present invention is to provide a user friendly interface simplifying the VLSI system design process.

Other objects and advantages of the present invention will become apparent from the following description taken in connection with the accompanying drawings, wherein, by way of illustration and example, the aspects of the present invention are disclosed.

### SUMMARY OF THE INVENTION

The present invention relates to a method and framework for designing of VLSI circuit using graphical user interface. The framework of the present invention provides a GUI that installed in an application such Microsoft PowerPoint™. The GUI comprises of multiple modules such as a design tool bar module, a user library module, a waveform creation module, a code generation module, a Unified Power Format (UPF) and a low power intent generation module. First a user create a circuit with use of in-built components, and saves into a user library. The method comprises of selecting one or more components from a design tool bar module and/or a user library module configured within a graphical user interface (GUI) for creating a system/circuit design. The GUI is installed as plug in in an application. Further, based on the information provided by a user over a system unit of the design tool bar module, enabling creation of whiteboxes or blackboxes creating based on information provided by user over a system unit of the design tool bar module; providing connectivity information representing interconnections or interface between the selected components of the system design over a design plane or form responsive to the user commands over the GUI; specifying a hardware description language (HDL) from plurality of HDLs for HDL code generation into a hardware description language module or at system level, the HDL module is configured to generate HDL code representative of the determined HDL based on the connectivity information and input/output port information. A low-power intent generation module includes power and ground specifications for blocks, the definition of the power state table, and the generation of Unified Power Format (UPF) to representing the power specifications of the design. These low power states are configuration that defines the various low power state in which the device or system can operate to minimize power consumption while still maintaining certain functionality. Further, a timing waveform creation module comprises of plurality of waveform designing tools that generate timing waveforms representing digital signals of the generated design in responsive to the user inputs over the design plane; and exporting the generated HDL code to one or more synthesis and layout tools for hardware realization of the generated design.

### BRIEF DESCRIPTION OF DRAWINGS

The present invention will be better understood after reading the following detailed description of the presently preferred aspects thereof with reference to the appended drawings, in which the features, other aspects and advantages of certain exemplary embodiments of the invention will be more apparent from the accompanying drawing in which:

FIG. 1 illustrates an exemplary computer system and its operating environment in which the present invention is shown according to an embodiment of the present invention.

FIG. 2a-2b illustrates an exemplary screenshot of a graphical user interface act as plug in in an application according to embodiment of the present invention.

FIG. 3 illustrates an exemplary screenshot depicting point and connector unit of a design tool bar module of a Graphical User Interface (GUI).

FIG. 4a-4e illustrates in built components of the design tool bar module.

FIG. 4f illustrates the low-power components with power and ground pins.

FIG. 5a-5b illustrates an exemplary image of parameters option (black box) of GUI and representative image for created instance.

FIG. 5c-5d illustrate circuits with power specifications.

FIG. 6a-6b illustrates an exemplary image of parameters option (e.g., white box) of GUI that user can defined as per requirement and representative image for created instance.

FIG. 6c-6d illustrate circuits with power specifications.

FIG. 7a represent the parameters option in GUI that user can defined as per requirement.

FIG. 7b illustrates a representative image for created instance.

FIG. 7c-7d illustrates circuits with power specifications.

FIG. 8 illustrates an exemplary screenshot of a timing waveform creation module of the GUI.

FIG. 9 illustrates an exemplary use model representing usage of generated HDL being used for Electronic Design Automation (EDA) and serves as test suites.

FIG. 10 illustrates an example of cloud based application of the proposed system.

FIG. 11 illustrates a flowchart depicting way of building a VLSI system design using a Graphical User Interface (GUI) model.

FIG. 12 illustrates a flowchart depicting a HDL code generation process.

FIG. 13 illustrates creation of System design using the framework of the present invention.

FIG. 14a-14b illustrate a flowchart depicting the process of building the low-power intent specification for VLSI system design using a Graphical User Interface (GUI) model.

FIG. 15 illustrates timing waveforms created using the present invention's framework.

FIG. 16 illustrates an example of designed circuit using the framework of the present invention.

FIG. 17 illustrates a circuit designed with low-power intent information using the present invention's framework.

### DETAILED DESCRIPTION OF THE INVENTION

The following description describes various features and functions of the disclosed system with reference to the accompanying figures. In the figures, similar symbols identify similar components, unless context dictates otherwise. The illustrative aspects described herein are not meant to be limiting. It may be readily understood that certain aspects of the disclosed system can be arranged and combined in a wide variety of different configurations, all of which have not been contemplated herein. Accordingly, those of ordinary skill in the art will recognize that various changes and modifications of the embodiments described herein can be made without departing from the scope of invention. In addition, descriptions of well-known functions and constructions are omitted for clarity and conciseness.

Features that are described and/or illustrated with respect to one embodiment may be used in the same way or in a similar way in one or more other embodiments and/or in combination with or instead of the features of the other embodiments.

The terms and words used in the following description are not limited to the bibliographical meanings, but, are merely used to enable a clear and consistent understanding of the invention. Accordingly, it should be apparent to those skilled in the art that the following description of exemplary embodiments of the present invention are provided for illustrative purpose only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, steps, components or groups thereof. The equations used in the specification are only for computation purpose.

The present invention specifically relates to a method and framework for VLSI circuit design and constraint generation using graphical user interface. The present invention discloses an innovative framework that seamlessly integrates circuit design capabilities within a graphical interface such as Powerpoint. The framework offers a comprehensive suite of tools for circuit design, power planning, waveform creation, RTL code generation, a low power generation module, a Unified Power Format (UPF) generation and system-level design and integration. A method of the present invention streamlines process of the VLSI system design, enhances productivity, and improves the overall user experience. The inclusion of waveform creation allow users to create and manipulate timing waveforms, providing valuable insights into signal behaviour alongside the circuit design process, further improving the accuracy and reliability of the VLSI system design. The low-power intent generation module includes power and ground specifications for blocks, the definition of the power state table, and the generation of the UPF to representing the power specifications of the design. These low power states are configuration that defines the various low power state in which the device or system can operate to minimize power consumption while still maintaining certain functionality. The inclusion of capturing power intent along with design functionality is a unique capability of the system that ensures the design meets both functional and power goals.

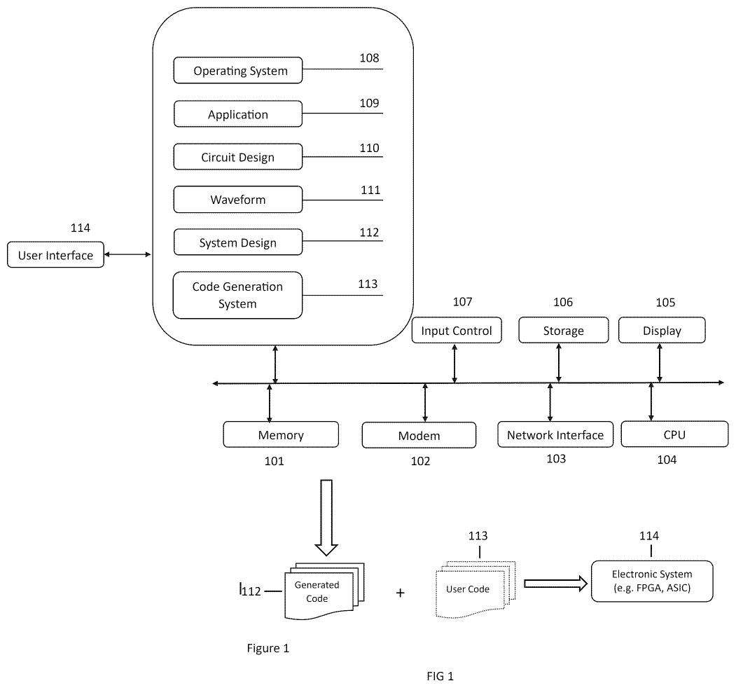

An exemplary computer system and its operating environment according to an embodiment of the present invention is illustrated in FIG. 1. According to an embodiment, the system/framework is an example of an internal configuration of a computing device that may be used to implement the integrated circuit design service infrastructure as a whole or one or more components of the integrated circuit design service infrastructure of the system. The system comprises of a computing device that may include a network interface, a modem, storage means (i.e. memory), a central processing unit (CPU), an input device, output interface and a display. The network interface is configured to provide network connectivity. In an embodiment, the input device is a keyboard and the output interface as display. It should be noted that the modem and network interface on the computing device can be used to connect it to communication network(s). Communication network may be any type of network known in the art supporting data communications. The communication network may be a local area network, a system BUS and/or the Internet.

The computing devices are selected from but not limited to a server, computer or super computer, workstation, network computer, Internet appliance, laptop, mobile device or smartphone, tablet computer, multiple computers connected over a network, a quantum computer, and a bio-computing device. The computing device is operated by a user with the help of input devices. Each computing device is employed with input devices which may include a microphone, a speaker, a camera or webcam, keyboard, joystick and mouse. The input devices that permit a user to program or otherwise use the system that can be provided in addition to or as an alternative to a display.

In an embodiment, support circuits for the framework of the present invention can include circuits such as cache, power supplies, clock circuits, and a communications bus. The memory can include random access memory (RAM), read only memory (ROM), disk drive, and tape drive.

The computer system may be configured around an internal bus connected to a microprocessor or processor and a bus controller. As shown in FIG. 1, according to an embodiment, an application is installed in the memory units of the computing device. The application module comprises plurality of modules. The application is configured to provide a user interface which is in data communication with the plurality of modules or blocks of the framework. The modules or blocks are selected from but not limited to, an operating system module, an application module, a circuit design module, a waveform creation module, Low power intent generation module and a RTL code generation module. According to a primary embodiment, the user interface acts as plug-in or add-in in the application such as Microsoft PowerPoint™.

The present invention may contain both text and graphics, or combine both types of information. According to an exemplary embodiment of the present invention allows for automatic code production from a model (circuit design) that has one or more blocks from the framework. The illustrative embodiment automatically generates code for the hardware description of the model. Similarly, the illustrative embodiment automatically generates power intent information in Unified Power Format (UPF).

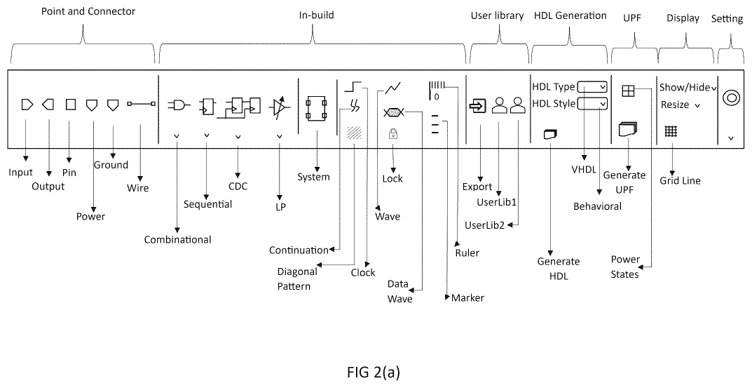

At first, the user launches the application such as Microsoft PowerPoint™ over the computing device and further opens a GUI of the application that is configured as add-in or plug in. The GUI includes multiple modules or options (as shown in FIG. 2) such as but not limited to, a design tool bar module, a user library module, a design plane or slide plane, a HDL code generation module, a waveform creation module, low power intent generation module and a control panel or settings. The GUI includes a ribbon and the ribbon employed with tabs including but not limited to file, home, insert, draw design, transitions, animations, slide show, record, review, view, SlideCircuitPro, and Help. It should be noted that, the proposed system is not limited to the power point-based system but can be implemented with any application environment or as an independent model. The framework offers a drag and drop functionality from the design tool bar module (hereinafter interchangeably referred as design tool bar) for adding pre-built components to the graphical user interface (GUI), and various connectors useful for connections between components through intuitive graphical interface. The design tool bar module includes but not limited to of multiple sections such as a point and connector unit, combination circuits, sequential circuits, clock domain crossing (CDC) circuits, and low power design circuits such as Isolation cell, level shifter, power switch, and voltage shifter.

The design tool bar module enable user to drag and drop components from built in library configured in the user library module of the GUI. The first step of designing of very large scale integration (VLSI) circuit involves creation of a circuit diagram using drag and drop components from the in-built library or user defined library and making connection between the components and/or their ports. The user library module include options such as export and one or more user libraries (for example, UserLib1, UserLib 2) that can be saved in the user library module. The export option allow users to export user-designed components into the user library module. The export option enable users of the application to save and reuse their custom-designed circuit elements in future designs. By exporting components to the user library, the user can build a repository of their own circuit elements, streamlining the design process and promoting design reuse. It should be noted that instance name, port name, and wire name default values are used as per predefined naming rules and provide flexibility to the user to change the values.

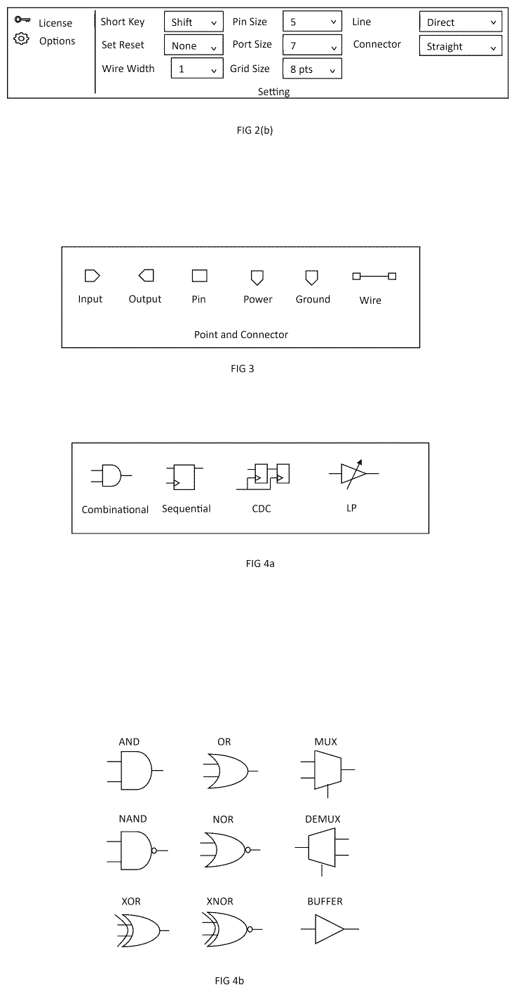

The point and connector unit includes but not limited to input, output, pin, power, ground, and wire as shown in FIG. 3. It is to be noted that, the user can select the points and connectors to build connection easily while designing a circuit over the GUI. The port and connector unit includes but not limited to pins, inputs, outputs, powers, grounds and wires, which enable users to create and connect circuit elements effortlessly. Such elements facilitate the construction of complex digital circuits along with optional power & ground ports within the familiar PowerPoint environment. It should be noted that, the wire creation can be started only from the connection point.

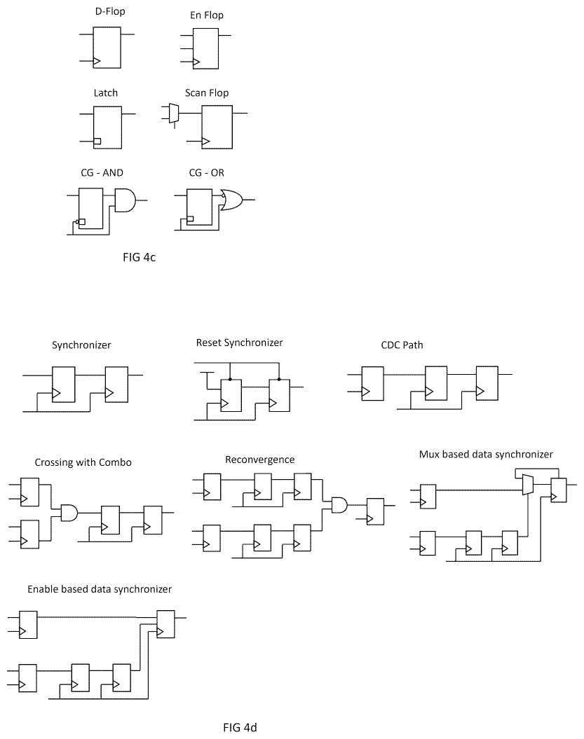

The design tool bar equipped with in-built components (as shown in FIG. 4a-4f) such as combinational circuits, sequential circuits, clock domain crossing circuits and low power circuits. The pre-built components allow users to quickly incorporate commonly used circuit elements into their designs, saving time and effort in the circuit design process. The design tool bar is employed with an additional feature where designer/user can use sequential element with or without reset/set, and this feature can be used to design Reset domain crossing components.

Referring to FIG. 4a-4f, the in-built components provides a library of pre-designed combinational circuits, sequential circuits, circuits related to clock domain crossing (CDC) and low power circuits. The combination circuits includes but not limited to, AND, OR, MUX, NAND, NOR, BUFFER, NOT, XOR, XNOR. The sequential circuits includes but not limited to, D-flop, Enable-Flop, latch, scan flop, and Clock gates. The CDC circuits are selected from but not limited to, synchronizer, reset synchronizer, CDC path, crossing with combo, reconvergenece, and mux based synthesizer. Low-power circuits, including but not limited to level shifters (both up and down), isolation cells (both low and high), power switches, retention elements, and combinations of isolation and level shifter cells, are carefully chosen.

In an embodiment, the GUI also provided with a configuration setting or control panel which comprises of set reset selection in the sequential circuit, pin/port/grid size selection, line/connector (can be selected from straight or elbow or line could be like direct XY, YX coordinates), options to define numbers of inputs for various combination circuits, and port widths. The GUI also employed with additional important option referred as show/hides, the show hides is used to show or hide pin name, instance name, design name, and port name. The GUI also provides options for drawing gridlines and resizing the graphical editor's width and height.

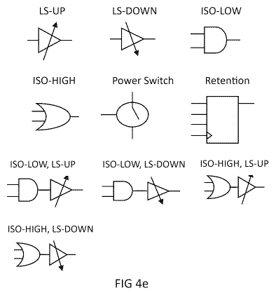

According to an embodiment of the invention, in order to create larger or complex system designs with use of pre-built blocks, the framework support the design of systems with various levels of complexity, from simple combinations of circuits to intricate architectures with interconnected modules. The user can employ pre-built system components from the user library module, which allows rapid system assembly. Users can employ pre-built system components from a library (for example, Userlib 1), allowing for rapid system assembly and integration. The GUI allow users to create their own custom-designed blackboxes or whiteboxes, providing the flexibility to incorporate specialized functionalities or unique system components into the overall system design. FIG. 5a represent an exemplary image of parameters option (e.g., black box) of GUI that user can define as per their requirement. The user can define Instance name, design name, HDL type, number of inputs, number of outputs, color fill for the box and optional power pins. FIG. 5b depicts a representative image for created instance without power pins. FIG. 5c additionally has parameters to define the number of power and ground connections. FIG. 5d represents a typical image of a created instance with power pins.

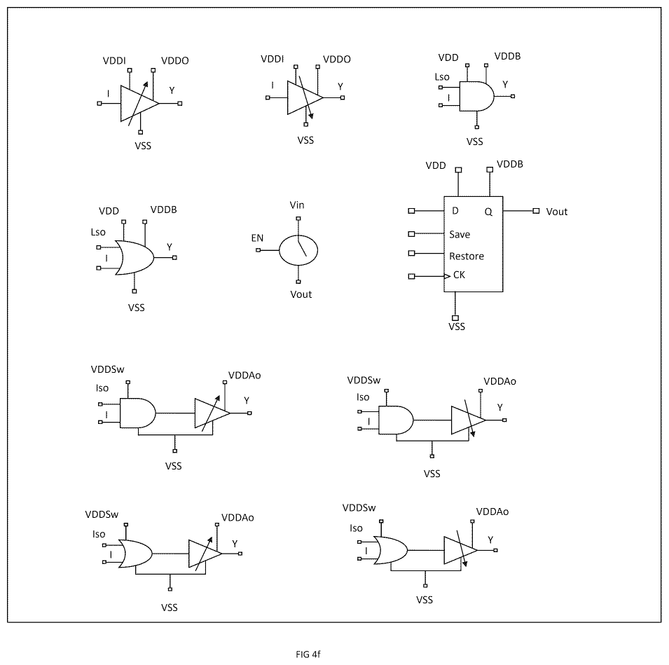

FIG. 6a illustrates an exemplary image of parameters option (e.g., whitebox) of GUI that user can defined as per requirement. FIG. 6b is a representative image for created instance. The user can define Instance name, design name, HDL type, number of inputs, number of outputs, color fill for the box and optional power pins. The user can define Instance name, design name, HDL type, number of inputs, number of outputs and color fill for the box. At first, the user can create instances of components used to design large system. Creation of instances of components allow for the instantiation and replication of specific circuit elements or modules, enabling the construction of larger and more complex systems. It offer flexibility to define the HDL language for the underlying block. FIG. 6c additionally has parameters to define the number of power and ground connections. FIG. 6d represents a typical image of a created instance with power pins.

In an exemplary embodiment, the user can create whitebox or blackbox components encapsulating the internal functionality of a circuit or module, allowing for a higher level of abstraction. The blackbox components simplify the system design process by treating the whitebox/blackbox as a single entity without revealing its internal details. The user can create whitebox components within a system. Whitebox components provide a transparent view of the internal circuitry of the system. The framework also provide an option to create an instance from user created design by selecting user library, and load all design available in that library, and user can select any design and enable the user to customize and modify the underlying design. The GUI enables creation of an instance from the user created design by selecting from the user library module.

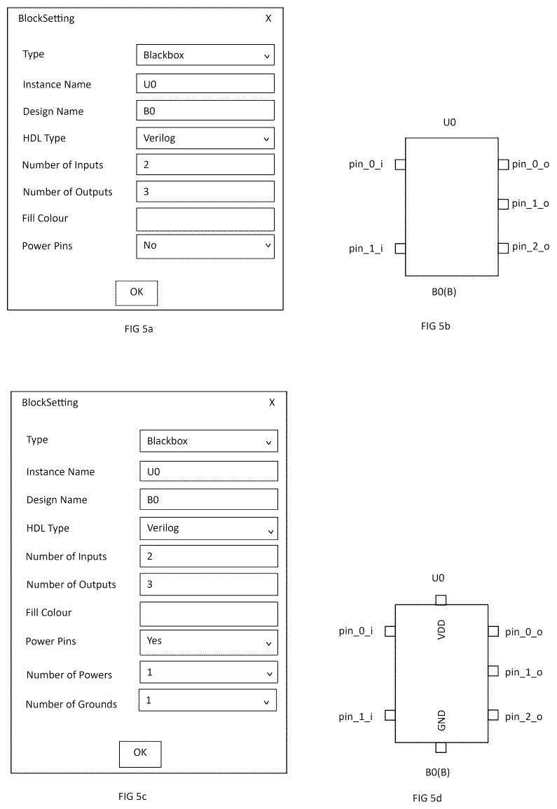

Referring to FIG. 7a, represent the parameters option GUI that user can defined as per requirement. The framework provide an option to select user library, and will load all design available in that library, and the user can select any design. FIG. 7b is a representative image for created instance. FIGS. 7c and 7d depicts representative image for created instance with power pins.

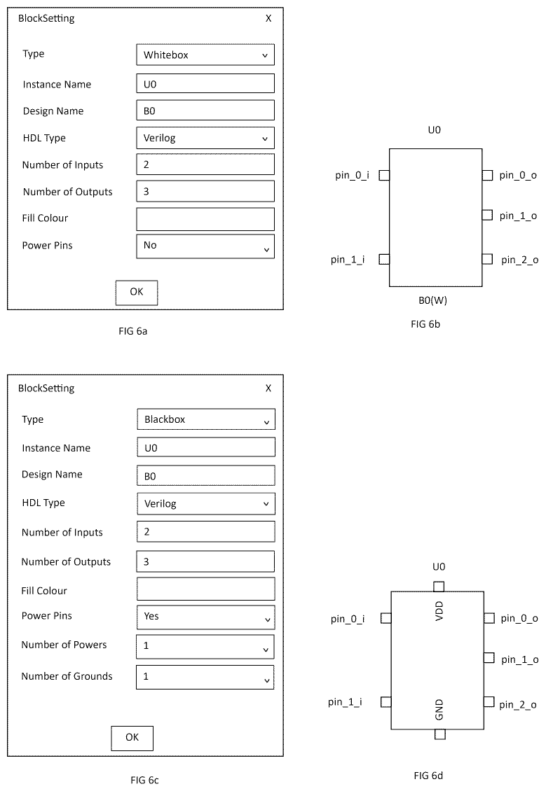

Further, the GUI is employed with a timing waveform creation module as shown in FIG. 8. The waveform allow users to create timing waveforms that represent the behavior of digital signals within the designed circuits. Users can define the timing characteristics of the signals, such as clock edges, data transitions, and signal levels, to accurately represent the desired circuit operation using the waveform creation module. The timing waveform creation module include options such as but not limited to, a clock, wave, ruler, continuation, data wave, maker, diagonal pattern, and lock. The timing waveform creation module allow users to create timing waveforms over the design plane representing digital signals associated with the circuit designs. The timing waveform creation module provide functionality to manipulate timing parameters, signal transitions, and signal levels within the waveforms to the user.

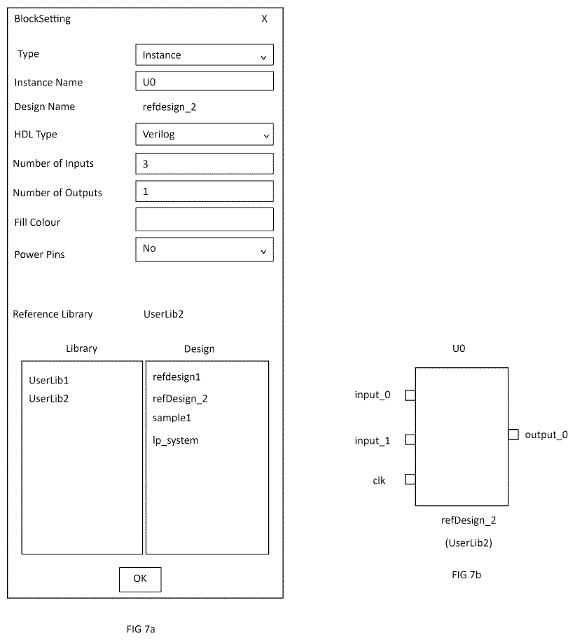

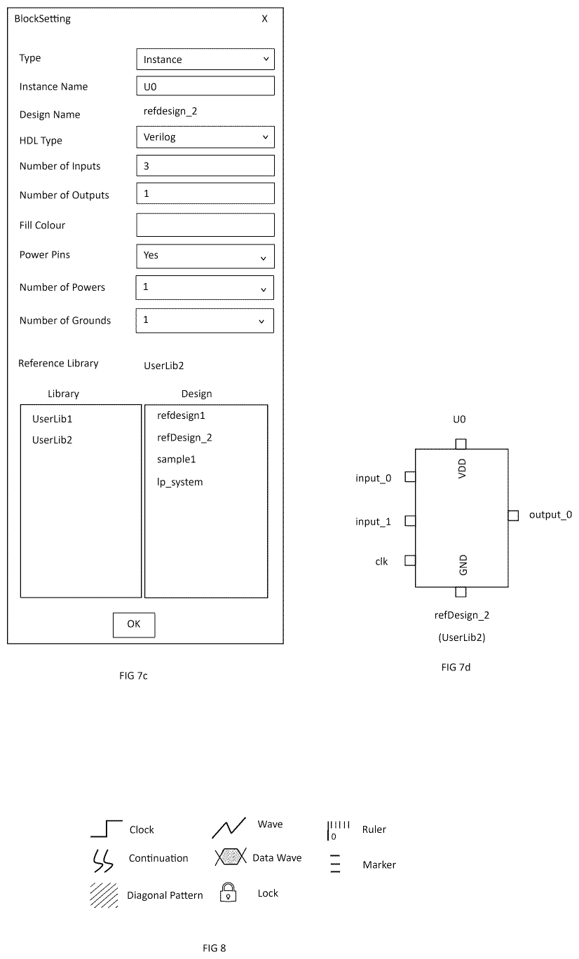

FIG. 9 is an exemplary use model representing usage of generated HDL being used for Electronic Design Automation (EDA) and serves as test suites. FIG. 10 is an exemplary example for cloud-based application of the proposed system. In an exemplary embodiment, the framework supports cloud based environment, where framework is available at the server, whereas designers can access tool and projects from anywhere with an internet connection. This way the framework becomes useful for remote teams, freelancers, or individuals who need to work on the go.

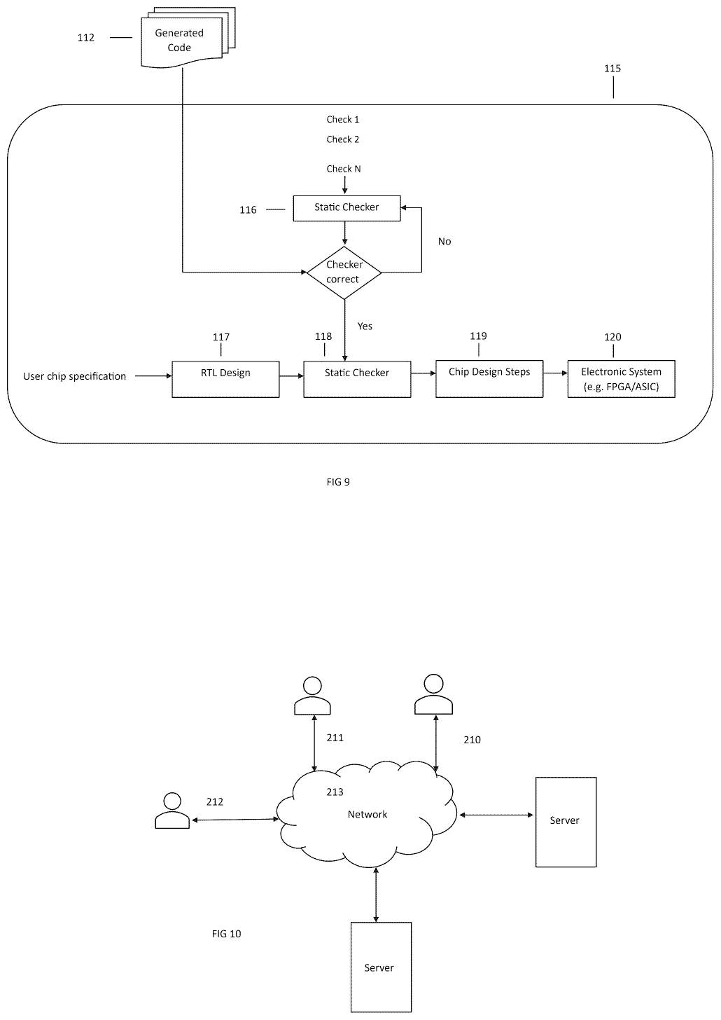

FIG. 11 illustrates a flowchart explaining exemplary operation of method and framework of VLSI system design using a Graphical User Interface (GUI) model. At first, the user launches the GUI over the application. In an exemplary embodiment, the system is not limited to the power point-based system but can be implemented with any application environment or as an independent model.

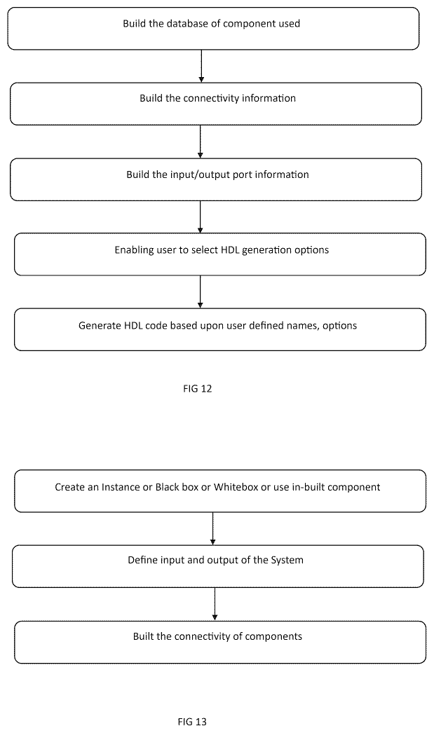

The process of the present invention is explained as follows: inserting or selecting components or multiple digital circuits from in built library or pre-saved user libraries and/or a design tool bar module over the GUI by the user into a design plane/form in order to form a larger system; establishing connections between the components responsive to the user selection over the GUI by using the input devices/peripherals; altering name of components/ports of the digital circuits (if required); generating a HDL code, by a HDL code generating module, for interface between two components of the design. It is to be noted that, the application allow users to create black boxes or white boxes by providing system parameters information over a system unit of the design tool bar module as illustrated in FIG. 13. The parameters includes but not limited to, type, instance name, design name, HDL type, number of inputs, number of outputs, fill color and optional power ports. The design can be created with or without power and ground ports.

Once the user has done the circuit creation and created the connectivity between the components. If user wanted to generate the HDL by pressing the button “Generate HDL” in the ribbon, then an internal algorithm or machine readable instructions installed in memory start processing the GUI (selected slide) to understand what is drawn by the user, and how connectivity is build. The information parsing is done in following ways. This parsed information is sufficient to understand the full circuit, and now based upon build information and selected HDL type, thereafter the HDL module based upon build information and selected HDL type start writing the code in the particular selected language style. Optionally user can export the created design into the user library. Further, the user can build the system using previously saved components in the user library.

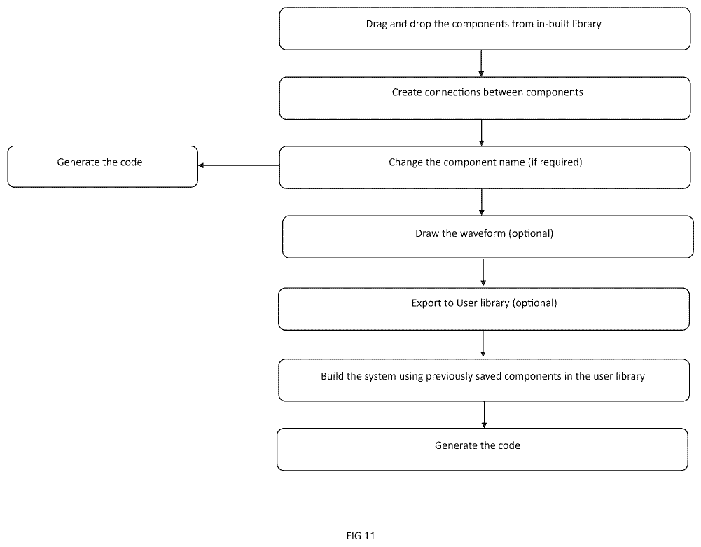

FIG. 12 is an exemplary HDL code generating process performed by the HDL module is explained as follows:
a) creating a database, by a GUI, that stores information about the components used in the circuit design. The information includes but not limited to, details such as component types, parameters, and characteristics of the components.
b) constructing connectivity information representing interconnections between the components. The connections between the components in the circuit design and builds the necessary connectivity information over the design plane or form. The connectivity information ensures that the generated HDL code accurately reflects the interconnections between different components.
c) determining input and output ports of the circuit and captures the necessary information about the input and output ports. The input/output information is essential for correctly defining the interface of the generated HDL code.
d) selecting a desired HDL language from plurality of options for code generation by the user. The options are selected from Verilog, VHDL, System Verilog, or other supported languages can be selected based on the user's preference or project requirements.
e) generating the corresponding HDL code for the circuit design based on the information gathered (such as connectivity information, input/output port information, selected HDL generation portion) in the previous steps (a-d). The generated code accurately represents the circuit's behavior and structure, making the system ready for further simulation, synthesis, or implementation stages of the digital design workflow.
f) exporting the generated HDL code to one or more synthesis and layout tools for hardware realization of the generated design.

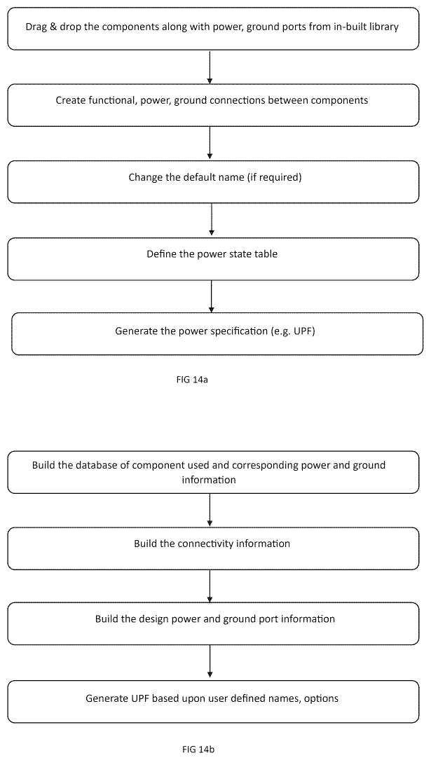

FIG. 14a illustrates the process representing user interactions for circuit design, including the generation of power intent information into UPF. Users can design a circuit along with power, and ground ports during system design while creating black-box, white-box, or instance components. The ‘LP’ library provides low-power-specific components, such as level shifters, isolation elements, and retention mechanisms. The power state table can be defined using the ‘Power States’ button in the ribbon. Once the desired components are placed, connectivity is established for both functional and power networks. After this user can generate UPF.

FIG. 14b represents an internal algorithm or machine-readable instructions stored in memory, which start processing the GUI (selected slide) to interpret the user's drawings and connectivity, both for functional and power aspects. Subsequently, the low-power intent module generates UPF based on the built information. The low-power intent module includes methods for designing circuits with power intent, specifying power and ground connections, defining the power state table, and effectively generating the power intent into the UPF.

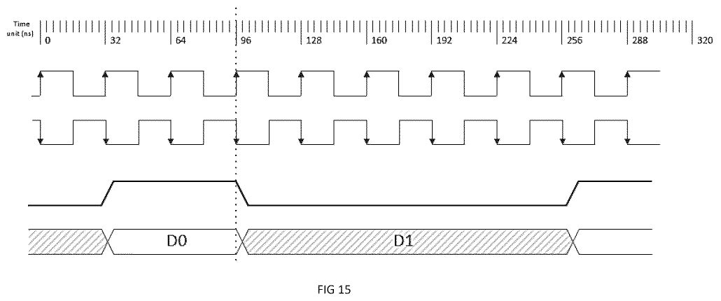

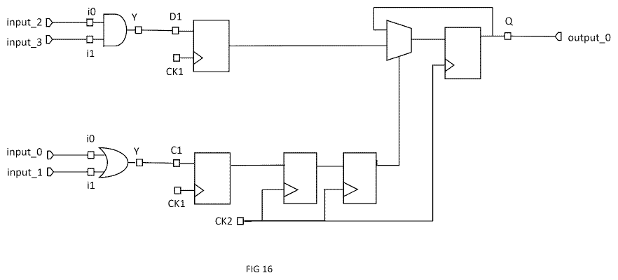

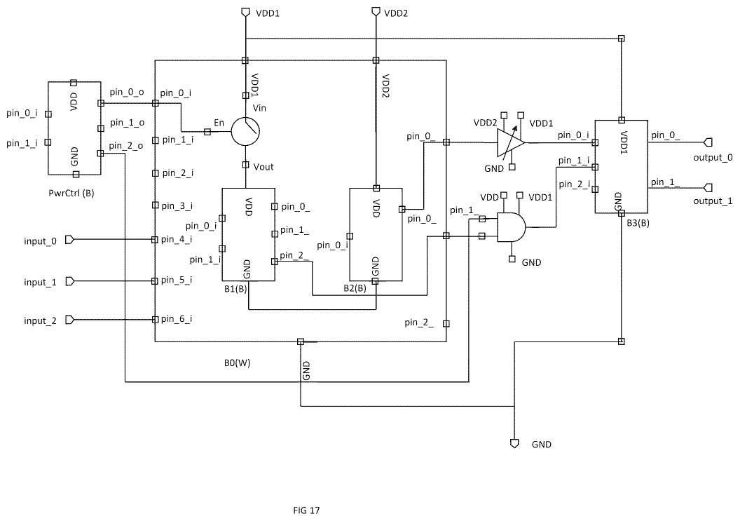

FIG. 15 serves as an illustrative example representing the waveform created by the timing waveform creation module. FIG. 16 serves as an illustrative example representing a circuit designed using built-in components, including combinational, sequential, and CDC (Clock Domain Crossing) components. FIG. 17 serves as an illustrative example of a circuit designed with consideration of design power intent, building the connectivity both for functional and power.

The present invention provides integration of circuit design capabilities within PowerPoint environment, its user-friendly approach that leverages existing knowledge, the comprehensive suite of tools it offers, and its emphasis on efficiency and reusability.

The advantages of the present invention are discussed herein:
The present invention provide a platform that seamlessly integrate circuit design capabilities within the widely used software environment of PowerPoint. This integration introduces easy to user GUI for circuit design that enhances user experience and streamlines the design process.
The present invention offers the comprehensive suite of tools including waveform creation, RTL code generation, Power intent generation and system-level design, further contributes to its non-obviousness. The system design feature of creating the blackboxes, whiteboxs or creating the instance creates a full logical view of the chip, and this design along with some additional information such as size, and physical design coordinate of the chip can be used to design a floorplan def file. The functionalities cater to the diverse needs of digital design workflows and provide users with a holistic solution for designing, visualizing, and manipulating digital circuits.
The present invention ability to circuit design along with power intent definition, and generation of power intent into the UPF, streamlines the design process in generating both functional and power view of the design.
The present invention has ability to export user-designed components to a user library for future reuse adds another layer of non-obviousness. Such feature promotes efficiency and reusability in circuit design, allowing users to build upon previously created components and accelerate the design process.
The present invention streamline workflows, save time and effort in the VLSI design process.
The present invention provides a comprehensive suite of tools provides a holistic approach to VLSI design.
Improved productivity and overall user experience.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

We claim:

1. A method for designing of VLSI circuit using graphical user interface, comprising of:
a) selecting one or more components from a design tool bar module and/or a user library module configured within a graphical user interface (GUI) for creating a system/circuit design, wherein the GUI is installed as plug in an application;
b) enabling creation of black boxes or whiteboxes based on input information provided on system parameters of a system unit by a user;
c) enabling creation of an instance from the user created system/circuit design by selecting from the user library module;
d) providing connectivity information representing interconnections or interface between the selected components of the system design over a design plane or form responsive to the user commands over the GUI;
e) specifying a hardware description language (HDL) from plurality of HDLs for HDL code generation into a hardware description language (HDL) module;
f) specifying a power intent information in the circuit/system design by the user and generating an Unified Power Format (UPF);
g) determining input and output ports information for a generated system design by the HDL module;
wherein,
i. the hardware description module is configured to generate HDL code representative of the determined HDL based on the connectivity information and input/output port information;
ii. a timing waveform creation module comprises of plurality of waveform designing tools that generate timing waveforms representing digital signals of the generated design in responsive to the user inputs over the design plane; and
iii. exporting the generated HDL code to one or more synthesis and layout tools for hardware realization of the generated design.

2. The method as claimed in claim 1, wherein the design tool bar module comprises of a point and connector unit, combinational circuits, sequential circuits, Clock Domain Crossing (CDC) circuits, and low power design circuits.

3. The method as claimed in claim 1, wherein the user library module allow the user to select components from one or more pre-saved user libraries and export.

4. The method as claimed in claim 1, wherein the input information is selected from a group comprises of component types, parameters, and characteristics.

5. The method as claimed in claim 1, wherein the whitebox or blackbox are generated based on parameters that are selected from a group comprising of blackbox components, whitebox components and instances of pre-designed components.

6. The method as claimed in claim 1, wherein the plurality of HDLs are selected from a group comprises of Verilog, very high-speed integrated circuit hardware description language (VHDL), and system verilog.

7. The method as claimed in claim 1, wherein the system parameters are selected from a group consisting of instance name, design name, HDL type, number of inputs, number of outputs and color fill.

8. The method as claimed in claim 1, wherein the user provide inputs or commands over the GUI using input devices of the computing device.

9. The method as claimed in claim 1, wherein a low-power intent module includes methods for designing circuits with power intent, specifying power and ground connections, defining the power state table, and effectively generating the power intent into the UPF.
